(19) United States
(12) Patent Application Publication
(10) Pub. No.: US 2017/0243220 A1
(43) Pub. Date: Aug. 24, 2017

(54) SYSTEMS AND METHODS FOR BLOCKING INELIGIBLE FRAUD-RELATED CHARGEBACKS

(71) Applicant: MasterCard International Incorporated, Purchase, NY (US)

(72) Inventors: Gregory S. Phillips, St. Louis, MO (US); Claire Le Gal, New York, NY (US)

(21) Appl. No.: 15/011,265

(22) Filed: Jan. 29, 2016

(51) Int. Cl. G06Q 20/40

(52) U.S. Cl. CPC G06Q 20/4016; G06Q 20/405

(57) ABSTRACT

A computer-implemented method for automatically blocking an ineligible fraud-related chargeback from chargeback processing over a network is provided. The method is implemented using a chargeback blocking (CB) computing device. The method includes determining, by the CB computing device, that a first fraud-related chargeback is a triggering fraud-related chargeback based at least in part on stored triggering rules. The method further includes determining if a second fraud-related chargeback is ineligible by applying the triggering rules. The method also includes blocking the second fraud-related chargeback from being transmitted over the network if the second fraud-related chargeback is determined to be ineligible.

### BACKGROUND OF THE DISCLOSURE

The field of the disclosure relates generally to electronically processing chargebacks and, more particularly, to network-based systems and methods for automatically blocking ineligible fraud-related chargebacks for a payment card transaction.

In today's world, more and more payment transactions are initiated with payment cards or some other type of payment on an account. At least some of these transactions end up being disputed by one of the parties involved in the transaction. These disputed transactions are at least sometimes resolved through a chargeback process. At least some known chargeback requests result from fraudulent transactions associated with a payment card account. In at least some known instances, an issuer bank (also known as the issuer) fails to promptly close an account that is used in a potentially fraudulent transaction (also referred to as a “suspect transaction”). Rather, the issuer continues to present the suspect transactions to a merchant bank (also known as an acquirer bank or an acquirer) for chargebacks. The chargebacks are typically passed on from the acquirer to a merchant involved in the suspect transaction. In the chargeback process, the acquirer is given the opportunity to dispute the issuer's presentment of one or more chargebacks. The acquirer can re-present the disputed transactions to the issuer, accompanied by supporting evidence to prove that the chargebacks were improper. In return, the issuer can dispute the acquirer's representment of the chargeback, whereupon the disputed chargebacks may be settled through an arbitration process.

These suspect transactions present liability issues to the merchant, the issuer, and the acquirer, and are responsible for a significant amount of financial losses. The processing of these suspect transactions over the network is also a considerable burden on the bandwidth of the network. Accordingly, a system for reducing a number of suspect transactions associated with a payment account is needed.

### BRIEF DESCRIPTION OF THE DISCLOSURE

A computer-implemented method for automatically blocking an ineligible fraud-related chargeback from chargeback processing over a network is provided. The method is implemented using a chargeback blocking (CB) computing device including a processor and a memory. The method includes storing triggering rules in the memory. The triggering rules are configured to determine whether a fraud-related chargeback is a triggering fraud-related chargeback. The triggering rules include at least one rule defining a notification date for a triggering fraud-related chargeback, and at least one rule defining a counter value for a triggering fraud-related chargeback. The method further includes receiving, by the CB computing device from a network, a first chargeback for an account associated with a cardholder, the chargeback including an account identifier. The method also includes determining, by the CB computing device, that the first chargeback is a first fraud-related chargeback. The method further includes determining, by the CB computing device, that the first fraud-related chargeback is a triggering fraud-related chargeback based at least in part on the stored triggering rules. The method also includes receiving, by the CB computing device from a network, a second fraud-related chargeback after determining the first fraud-related chargeback is the triggering fraud-related chargeback. The method further includes determining if the second fraud-related chargeback is an ineligible fraud-related chargeback by applying the triggering rules. The method also includes blocking the second fraud-related chargeback from being transmitted over the network if the second fraud-related chargeback is ineligible.

A chargeback blocking (CB) computing device for automatically blocking an ineligible fraud-related chargeback from chargeback processing over a network is provided. The CB computing device includes a processor and a memory coupled to the processor. The processor is configured to store triggering rules in the memory. The triggering rules are configured to determine whether a fraud-related chargeback is a triggering fraud-related chargeback. The triggering rules include at least one rule defining a notification date for a triggering fraud-related chargeback, and at least one rule defining a counter value for a triggering fraud-related chargeback. The processor is further configured to receive, from a network, a first chargeback for an account associated with a cardholder, the chargeback including an account identifier. The processor is also configured to determine that the first chargeback is a first fraud-related chargeback. The processor is further configured to determine that the first fraud-related chargeback is a triggering fraud-related chargeback based at least in part on the stored triggering rules. The processor is also configured to receive, from a network, a second fraud-related chargeback after determining the first fraud-related chargeback us the triggering fraud-related chargeback. The processor is further configured to determine if the second fraud-related chargeback is ineligible by applying the triggering rules. The processor is also configured to block the second fraud-related chargeback from being transmitted over the network if the second fraud-related chargeback is ineligible.

A computer-readable storage media having computer-executable instructions embodied thereon is provided. When executed by at least one processor associated with a chargeback blocking (CB) computing device, the computer-executable instructions cause the processor to store triggering rules in the memory. The triggering rules are configured to determine whether a fraud-related chargeback is a triggering fraud-related chargeback. The triggering rules include at least one rule defining a notification date for a triggering fraud-related chargeback, and at least one rule defining a counter value for a triggering fraud-related chargeback. The computer-executable instructions further cause the processor to receive, from a network, a first chargeback for an account associated with a cardholder, the chargeback including an account identifier. The computer-executable instructions also cause the processor to determine that the first chargeback is a first fraud-related chargeback. The computer-executable instructions further cause the processor to determine that the first fraud-related chargeback is a triggering fraud-related chargeback based at least in part on the stored triggering rules. The computer-executable instructions also cause the processor to receive, from a network, a second fraud-related chargeback after determining the first fraud-related chargeback is the triggering fraud-related chargeback over the network. The computer-executable instructions further cause the processor to determine if the second fraud-related chargeback is ineligible by applying the triggering rules. The computer-executable instructions also cause the processor to block the second fraud-related chargeback from being transmitted over the network if the second fraud-related chargeback is ineligible.

### BRIEF DESCRIPTION OF THE DRAWINGS

FIGS. 1-8 show example embodiments of the systems and methods described herein.

FIG. 1 is a schematic diagram illustrating an example multi-party payment card industry system for enabling payment-by-card transactions.

FIG. 2 is a flow diagram showing a dataflow of settling chargeback transactions with a chargeback blocking (CB) computing device in accordance with one embodiment of the present disclosure.

FIG. 3 is a block diagram of an example payment card system including a CB computing device, in accordance with one embodiment of the present disclosure.

FIG. 4 illustrates an example configuration of a server computing device such as the server system shown in FIG. 3.

FIG. 5 illustrates an example configuration of a client computing device operated by a user as shown in FIG. 3.

FIG. 6 is a data flow block diagram of a payment card system that includes a CB computing device as shown in FIGS. 2 and 3, in accordance with one embodiment of the present disclosure.

FIG. 7 is a flow diagram showing a method of blocking ineligible fraud-related chargebacks using the CB computing device shown in FIGS. 3 and 4, in accordance with one embodiment of the present disclosure.

FIG. 8 is a block diagram of example fraudulent transactions that include a notification date and a counter value in accordance with one embodiment of the present disclosure.

### DETAILED DESCRIPTION OF THE DISCLOSURE

Disclosed herein is a chargeback blocking (CB) computing device, system, and method for blocking ineligible fraud-related chargebacks based on at least one of a fraud notification date and a counter value. The CB computing device includes at least one processor in communication with a memory and a network for processing payment transaction messages. The CB computing device is configured to receive fraud-related chargeback data, including at least an account identifier of an account holder, over the network from an issuer. The CB computing device is further configured to assign a notification date to the account identifier in response to receiving a triggering fraud-related chargeback. The CB computing device is still further configured to block fraud-related chargebacks associated with payment transactions authorized by the issuer after the notification date. The CB computing device is also configured to block fraud-related chargebacks once a total number of fraud-related chargebacks associated with an account identifier exceeds a predefined counter value.

In the example embodiment, an issuer submits chargebacks, which include chargeback data, to a network (e.g., a payment processing network, an interchange network, or a clearinghouse network). The CB computing device receives the chargebacks from the network and identifies fraud-related chargebacks based on a reason code included in the chargeback data. The reason code, which is typically assigned to the chargeback transaction by the issuer, may identify the chargeback as fraud-related. In these cases, the CB computing device is configured to identify the fraud-related reason codes and then analyze the chargeback further. The chargeback data further includes, but is not limited to, transaction data, such as, for example, a primary account number or identifier (either real or virtual), a transaction amount, a merchant identifier, an acquirer identifier, a transaction date-time, and an address verification. The fraud-related chargebacks are stored into tables in the memory and are retrievable by the account identifiers. Each account identifier in the memory further includes, but is not limited to, a total number of chargebacks submitted by an issuer for the account identifier, a counter value, and, if one was assigned, a notification date.

In the example embodiment, the CB computing device receives a triggering fraud-related chargeback, resulting in the CB computing device assigning a notification date to the account identifier. The triggering fraud-related chargeback occurs after the issuer has submitted a predefined number of fraud-related chargebacks involving the same account identifier. For example, in some embodiments, the second fraud-related chargeback submitted by the issuer may be the triggering fraud-related chargeback resulting in a notification date, the idea being that an issuer should know that an account has been compromised after two fraud-related transactions involving the same account identifier are charged back. The notification date is the date and time that the triggering fraud-related chargeback is received by the CB computing device.

Once a notification date is associated with an account identifier, for every other fraud-related chargeback involving the account identifier, the CB computing device is configured to compare a transaction date included in the chargeback data with the notification date. In some cases, an issuer may continue to authorize transactions made on an account where the issuer should have known that the account was compromised. The CB computing device is configured to address this problem. If the transaction occurred after the notification date, the CB computing device blocks the fraud-related chargeback from being submitted to the corresponding acquirer as part of the chargeback process. Thus, these blocked fraud-related chargebacks are not further processed within the network, which reduces the impact of these chargebacks on the network infrastructure. For example, where a notification date is assigned to an account identifier on January 5 and a fraudulent transaction was authorized by an issuer on the account identifier on January 10, if the issuer submits the fraudulent transaction for a chargeback on January 15, the CB computing device will block the chargeback as being ineligible because the transaction was authorized after the notification date. Conversely, the CB computing device will not block a fraudulent transaction that was authorized on January 4, but submitted for a chargeback on January 15 since the transaction was authorized before the notification date.

In a further embodiment, the CB computing device may receive a triggering fraud-related chargeback when a number of submitted fraud-related chargebacks equals a predefined counter value. The CB computing device is configured to count, for each account identifier, the number of fraud-related chargebacks submitted by an issuer. The triggering fraud-related chargeback occurs once the counted number of fraud-related chargebacks submitted on an account identifier equals the counter value, resulting in the CB computing device blocking any subsequent fraud-related chargebacks from being transmitted to the acquirer. For example, if the counter value is 25, and the CB computing device determines that 30 chargebacks have been submitted by an issuer, the CB computing device will determine that the 25^{th} chargeback is a trigger and the CB computing device will block subsequent chargebacks from being transmitted to the acquirer. In this example, the CB computing device will transmit 25 chargebacks to the acquirer for processing and will block the other 5 chargebacks as being ineligible for exceeding the counter value. In some embodiments, the ineligible chargebacks are selected from a batch of chargebacks based on an order that the chargebacks are received by the CB computing device. In alternative embodiments, the ineligible chargebacks are selected based on the transaction authorization date and time.

In one or more embodiments, the CB computing device appends the notification date to all fraud-related chargeback records occurring after the notification date for the account identifier. For example, for any chargeback records transmitted to the acquirer after the notification date, the CB computing device will append the notification date to the chargeback message (i.e., presentment) transmitted to the acquirer.

The CB computing device is configured to use a predefined period of time when counting the number of fraud-related chargebacks submitted on an account identifier, for example, but not limited to, 120 days or 360 days. A fraud-related chargeback older than the predefined period of time will not be counted towards the number of submitted fraud-related chargebacks on the account identifier.

Upon blocking one or more ineligible fraud-related chargebacks, the CB computing device is further configured to generate and transmit a notification to the issuer and the acquirer that includes an explanation and/or a reason code for blocking the fraud-related chargeback. In the example embodiment, the notification is formatted based on the data included in the blocked fraud-related chargeback.

In the example embodiment, the CB computing device is configured to block one or more ineligible fraud-related chargebacks. In alternative embodiments, these steps may be performed in a different order and/or one or more of the steps may be omitted. Specifically, the CB computing device is configured to perform the following: (i) receive a plurality of chargebacks from one or more issuers, where each chargeback is associated with an account identifier; (ii) identify, based on a chargeback reason code associated with each chargeback, fraud-related chargebacks from the plurality of chargebacks, wherein if a chargeback is not fraud-related, the chargeback is transmitted to a network for chargeback processing; (iii) count, for each account identifier, a number of fraud-related chargebacks submitted by an issuer, and determine when a triggering fraud-related chargeback occurs, the triggering fraud-related chargeback being a predefined number of fraud-related chargebacks submitted by the issuer on the same account identifier, resulting in the CB computing device assigning a notification date to the account identifier; (iv) count, for each account identifier, a number of fraud-related chargebacks submitted by an issuer to determine if the number of submitted fraud-related chargebacks exceeds a predefined counter value; (v) for each fraud-related chargeback, determine whether a notification date is associated with the account identifier or whether the number of submitted fraud-related chargebacks associated with the account identifier exceeds the predefined counter value; (vi) if there is no notification date associated with the account identifier and the number of submitted fraud-related chargebacks is less than or equal to the predefined counter value, the fraud-related chargeback is transmitted to the network for chargeback processing; (vii) if there is a notification date associated with the account identifier, the CB computing device is configured to compare the transaction authorization date of the fraud-related chargeback to the notification date and block the fraud-related chargeback from being transmitted to the network for chargeback processing if the transaction was authorized after the notification date; (viii) If the transaction was authorized before the notification date, the fraud-related chargeback is transmitted to the network for chargeback processing; and (ix) if the number of submitted fraud-related chargebacks exceeds the predefined counter value, the CB computing device is configured to block the fraud-related chargeback from being transmitted to the network for chargeback processing.

At least one of the technical problems addressed by the system described herein includes: (i) a high network load based, at least in part, on a high number of fraudulent transactions being transmitted to a payment processing network for chargeback processing, which results in network delays and reduced bandwidth; (ii) high network load, based at least in part, on otherwise ineligible or avoidable chargebacks being transmitted to an acquirer, which results in network delays and reduced bandwidth; (iii) failure to close cardholder accounts after one or more fraudulent purchases; (iv) allowing fraudulent transactions to be processed on the payment processing network as authorized transactions; (v) allowing ineligible fraudulent transactions to be processed as chargebacks; (vi) consumer inconvenience based at least in part on having to request chargebacks on fraudulent transactions; (vii) canceling payment card accounts issued to consumers due to continued fraudulent transactions, thus leading to lost sales for merchants and lost processing fees for the other network parties based on those lost transactions; and (vii) increased risk with merchant liability for fraudulent transactions.

A technical effect of the systems and processes described herein is achieved by performing at least one of the following steps: (i) receiving, from an issuer, chargeback data resulting from a payment card transaction; (ii) identifying fraud-related chargebacks based at least in part on the chargeback data; (iii) receiving a triggering fraud-related chargeback resulting in a CB computing device; (iv) blocking ineligible fraud-related chargebacks from being transmitted to an acquirer; and (vi) transmitting a notification to the issuer and the acquirer that includes an explanation for blocking the fraud-related chargebacks and/or a reason code.

The technical effect achieved by this system is at least one of: (i) reducing an amount of network and computing resources needed to process fraudulent transactions; (ii) reducing a number of fraudulent transactions being processed; (iii) reducing an amount of network and computing resources needed to process chargebacks; (iv) reducing a number of chargebacks being processed; (v) reducing consumer inconvenience; (vi) reducing a number of transactions that are lost due to consumers canceling their payments cards due to fraudulent transactions, and thus reducing lost sales for merchants and reducing lost fees for other network parties based on those lost transactions; and (vii) enabling liability shift to issuers for some transactions, such that issuers are incentivized to close accounts with fraudulent transactions or relinquish their fraud-related chargeback rights for any further fraudulent transactions associated with the accounts. For example, network resources and computing resources are reduced by reducing the number of fraudulent transactions. Network resources and computing resources are further reduced by reducing the number of chargebacks, and thus reducing the number of chargebacks transmitted and processed across the network. Instead of allowing every fraudulent transaction to be submitted by the issuer as a chargeback, the present system intelligently blocks the submission of certain fraud-related chargebacks after a criterion is met. One or more of the parties to the transaction are benefitted by the system by, for example, less burden on the consumer to report fraudulent transactions and request chargebacks, less lost sales and less processing of chargebacks for the merchant and the acquirer, and less lost sales and less processing of chargebacks for the issuer.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, digital wallets, and/or computers. Each type of transactions card can be used as a method of payment for performing a transaction. As used herein, the term “payment account” is used generally to refer to the underlying account with the transaction card. In addition, cardholder card account behavior can include but is not limited to purchases, management activities (e.g., balance checking), bill payments, achievement of targets (meeting account balance goals, paying bills on time), and/or product registrations (e.g., mobile application downloads).

The following detailed description illustrates embodiments of the disclosure by way of example and not by way of limitation. It is contemplated that the disclosure has general application to blocking chargebacks in industrial, commercial, and residential applications, and not limited to fraud-related chargebacks. For example, in some embodiments, the CB computing device blocks chargebacks submitted by an issuer where an account identifier is not listed in a warning bulletin at the time of a transaction. In some alternative embodiments, the CB computing device blocks chargebacks where an issuer claims the transaction was not authorized but it is shown by a clearing record that the transaction was authorized by an embedded chip in a credit or debit card.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

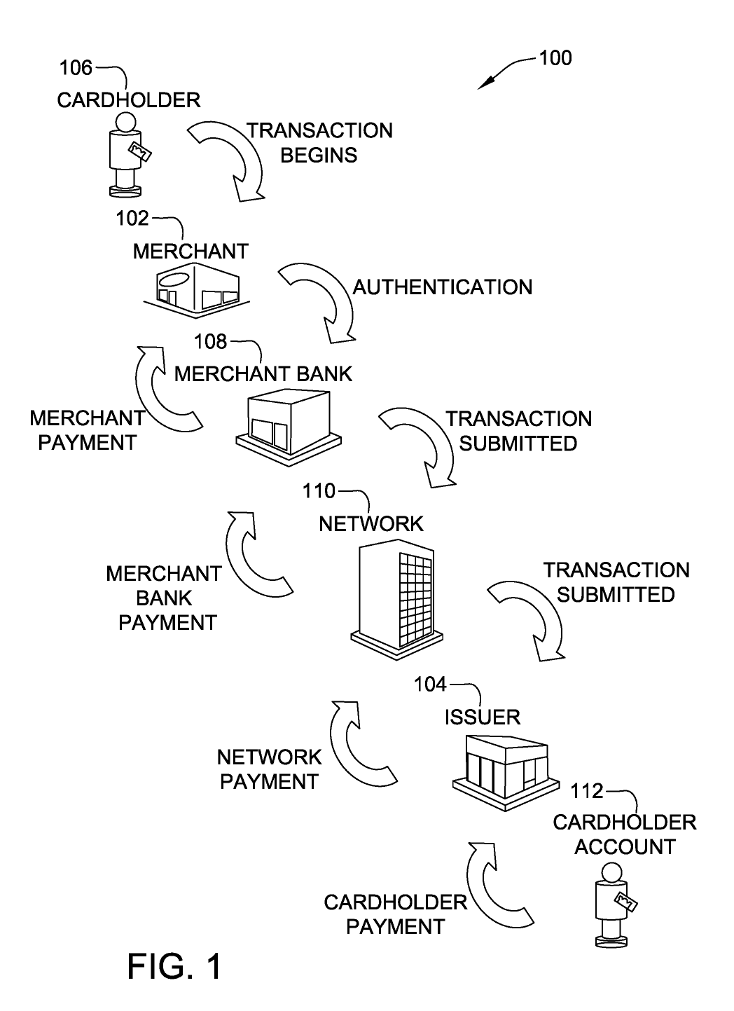

FIG. 1 is a schematic diagram illustrating an exemplary multi-party transaction card industry system 100 for enabling payment-by-card transactions between merchants 102 and card issuers 104. The present disclosure relates to payment card system 100, such as a credit card payment system using the MasterCard® payment card system payment network 110 (also referred to as an “interchange” or “interchange network”). MasterCard® payment card system payment network 110 is a proprietary communications standard promulgated by MasterCard International Incorporated® for the exchange of financial transaction data between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to a consumer or cardholder 106, who uses the transaction card to tender payment for a purchase from a merchant 102. To accept payment with the transaction card, merchant 102 must normally establish an account with a financial institution that is part of the financial payment system. This financial institution is usually called the “merchant bank,” the “acquiring bank,” or the “acquirer.” When cardholder 106 tenders payment for a purchase with a transaction card, merchant 102 requests authorization from an acquirer 108 for the amount of the purchase. The request may be performed over the telephone, but is usually performed through the use of a point-of-sale terminal, which reads cardholder's 106 account information from a magnetic stripe, a chip, or embossed characters on the transaction card and communicates electronically with the transaction processing computers of acquirer 108. Alternatively, acquirer 108 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 110, computers of acquirer 108 or merchant processor will communicate with computers of an issuer 104 to determine whether cardholder's account 112 is in good standing and whether the purchase is covered by cardholder's 106 available credit line. Based on these determinations, the request for authorization will be declined or accepted. If the request is accepted, an authorization code is issued to merchant 102.

When a request for authorization is accepted, the available credit line of cardholder's account 112 is decreased. Normally, a charge for a payment card transaction is not posted immediately to cardholder's account 112 because bankcard associations, such as MasterCard International Incorporated®, have promulgated rules that do not allow merchant 102 to charge, or “capture,” a transaction until goods are shipped or services are delivered. However, with respect to at least some debit card transactions, a charge may be posted at the time of the transaction. When merchant 102 ships or delivers the goods or services, merchant 102 captures the transaction by, for example, appropriate data entry procedures on the point-of-sale terminal. This may include bundling of approved transactions daily for standard retail purchases. If cardholder 106 cancels a transaction before it is captured, a “void” is generated. If cardholder 106 returns goods after the transaction has been captured, a “credit” is generated. Interchange network 110 and/or issuer 104 stores the transaction card information, such as a type of merchant, amount of purchase, date of purchase, in a data warehouse (not shown).

After a purchase has been made, a clearing process occurs to transfer additional transaction data related to the purchase among the parties to the transaction, such as acquirer 108, interchange network 110, and issuer 104. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction.

As used herein, the term “transaction data” refers to data that includes at least a portion of a cardholder's account information (i.e., cardholder name, account identifier, credit line, security code, and/or expiration data) and at least a portion of purchase information (i.e., price, a type of item and/or service, SKU number, item/service description, purchase date, and/or confirmation number) supplied by a merchant from which the cardholder is making a purchase.

After a transaction is authorized and cleared, the transaction is settled among merchant 102, acquirer 108, and issuer 104. Settlement refers to the transfer of financial data or funds among cardholder's account 112, acquirer 108, and issuer 104 related to the transaction. Usually, transactions are captured and accumulated into a “batch,” which is settled as a group.

In some transactions, cardholder 106 may request a refund or initiate a chargeback of funds. In addition, a chargeback may occur for technical reasons such as insufficient funds, clerical reasons such as duplicate billing and/or incorrect amount billed, quality reasons such as when a consumer claims to have never received the goods as promised, and/or fraud reasons where a consumer did not authorize the purchase.

To initiate a chargeback, cardholder 106 contacts issuer 104 and disputes a transaction. Issuer 104 submits the chargeback for the transaction to interchange network (i.e., payment processor) 110, which provides clearing and settlement services to its members. Interchange network 110 submits the chargeback to acquirer 108. Acquirer 108 either resolves the dispute or forwards it to merchant 102. Merchant 102 either accepts the chargeback or re-presents it back to acquirer 108. Acquirer 108 forwards the response from merchant 102 back to interchange network 110. Interchange network 110 then settles the chargeback with issuer 104. Based on the response, issuer 104 either reposts the charge to cardholder account 112 or resubmits the transaction to interchange network 110 for a financial liability decision. Issuer 104 also provides cardholder 106 a dispute resolution summary. In some embodiments, the third party issuer processor performs chargeback processing on behalf of issuer 104. In these embodiments, issuer 104 submits chargeback messages that include reason codes to the issuer processor, and the issuer processor communicates with interchange network 110 to settle the chargeback. Issuer 104 may choose to receive the settlement funds directly from interchange network 110 after settlement occurs, or alternatively, issuer 104 may authorize the issuer processor to settle with interchange network 110, and then issuer 104 settles with the issuer processor.

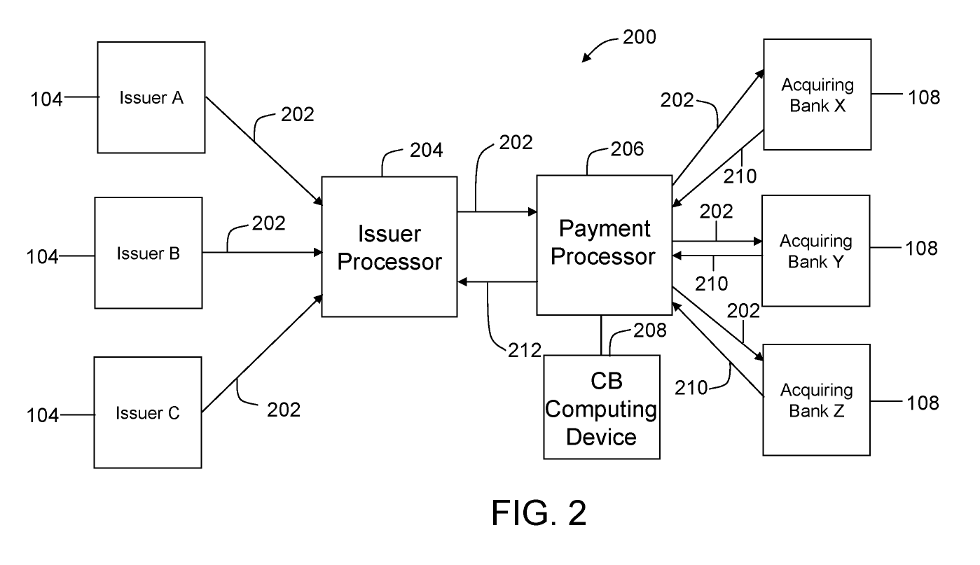

FIG. 2 is a data flow block diagram of a payment card system 200 used to settle chargeback transactions that includes a chargeback blocking (CB) computing device 208. As part of the chargeback process, at least one issuer 104 transmits a chargeback request received from a cardholder (not shown) as a chargeback transaction 202 to an issuer processor 204 for chargeback settlement. Chargeback transaction 202 includes the transaction data relating to the original transaction. Issuer processor 204 generates a batch file of chargeback transactions 202, which include multiple chargeback transactions 202 from multiple issuers 104, to transmit to a payment processor 206 for chargeback settlement. Payment processor 206 includes or is in communication with CB computing device 208. Payment processor 206 processes chargeback transactions 202 and transmits chargeback transactions 202 to acquirers 108 determined from the transaction data included within chargeback transactions 202 for settlement. Payment processor 206 may communicate chargeback transactions 202 to CB computing device 208 before sending to acquirer 108. Payment processor 206 may be associated with payment card system interchange network 110.

In operation, issuer 104 (i.e., issuer A shown in FIG. 1) transmits chargeback transaction 202, including transaction data relating to the original transaction for which chargeback is requested, to issuer processor 204 for chargeback settlement. Issuer processor 204 creates a record for chargeback transaction 202 and stores it in the batch file. The detailed record includes transaction data, cardholder account identifier, and issuer ID assigned by issuer processor. Issuer processor 204 repeats this process for multiple chargeback transactions 202 received from multiple issuers 104 (i.e., issuers A, B, and C shown in FIG. 2). At the end of each day, issuer processor 204 transmits chargeback transactions 202, which includes multiple detailed records, to payment processor 206 for chargeback settlement.

As explained further below, CB computing device 208 receives chargeback transactions 202, from payment processor 206, to determine whether one or more fraud-related chargeback transactions 202 are ineligible for chargeback and should be blocked from being transmitted to acquirer 108. In some embodiments, payment processor 206 transmits data 212 back to issuer processor 204, which may include chargeback response message 210.

Payment processor 206 processes chargeback transactions 202 and transmits each chargeback transaction 202 to an associated acquirer 108 (i.e., acquirer X, Y, or Z shown in FIG. 2) based on the transaction data. In the example embodiment, payment processor 206 facilitates the clearing, settlement, and chargeback processing of transactions between acquirers 108 and issuers 104 (or issuer processors on behalf of issuers 104).

In one embodiment, acquirers 108 may not respond to a chargeback request. In alternative embodiments, acquirers 108 may transmit a chargeback response message 210 representing acknowledgement from acquirers 108 to payment processor 206. Inasmuch as chargeback transactions are known as “force post” transactions, chargeback transactions are settled whether or not acquirers 108 agree with chargeback transactions 202.

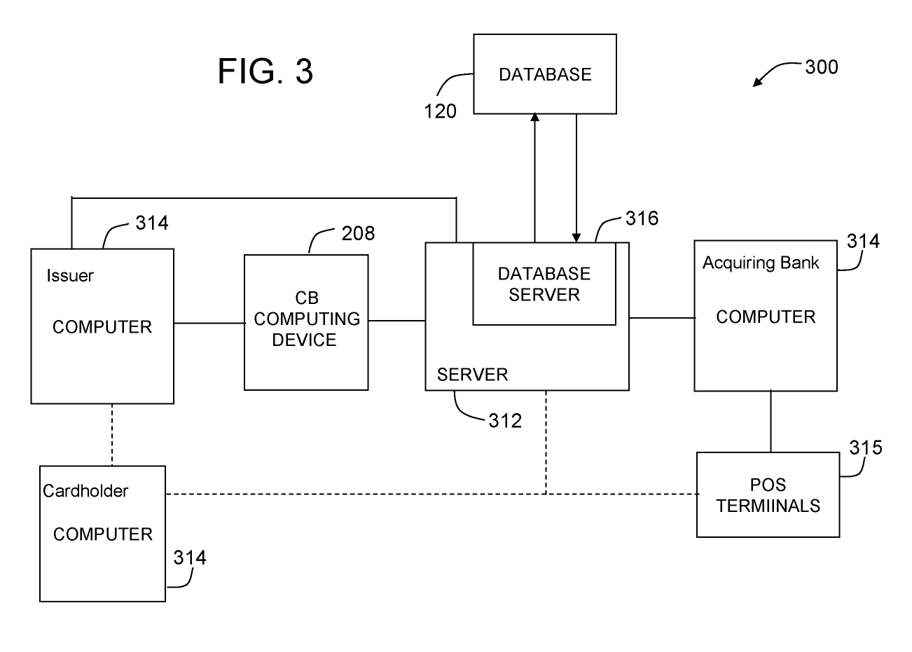

FIG. 3 is a block diagram of an example payment system 300 including CB computing device 208 for blocking fraud-related chargebacks in accordance with one embodiment of the present disclosure. In the example embodiment, CB computing device 208 is configured to block a fraud-related chargeback transaction between an issuer and an acquirer where (1) a payment transaction resulting in the fraud-related chargeback occurred after a notification date was associated with the account identifier, or (2) a total number of submitted fraud-related chargebacks exceeds a counter value. CB computing device 208 is further configured to transmit a notification to the issuer and acquirer that includes a reason that the fraud-related chargeback was blocked. The chargeback relates to a dispute lodged by a user with respect to at least one transaction assigned to an account associated with a cardholder.

In the example embodiment, system 300 includes a server system 312, which is a type of computer system, and a plurality of client sub-systems (also referred to as client systems 314) connected to server system 312. In one embodiment, client systems 314 are computers including a web browser, such that server system 312 is accessible to client systems 314 using the Internet. Client systems 314 are interconnected to the Internet through many interfaces including a network, such as a local area network (LAN) or a wide area network (WAN), dial-in-connections, cable modems, Integrated Services Digital Network (ISDN) lines, and/or fiber optic network lines. Client systems 314 could be any device capable of interconnecting to the Internet including a web-based phone, PDA, or other web-based connectable equipment.

System 300 also includes point-of-sale (POS) terminals 315, which are connected to client systems 314 and may be connected to server system 312. POS terminals 315 are interconnected to the Internet through many interfaces including a network, such as a LAN or a WAN, dial-in-connections, cable modems, wireless modems, ISDN lines, and/or fiber optic network lines. POS terminals 315 could be any device capable of interconnecting to the Internet and including an input device capable of reading information from a cardholder's financial transaction card.

A database server 316 is connected to database 320, which includes information on a variety of matters, as described below in greater detail. In one embodiment, centralized database 320 is stored on server system 312 and can be accessed by cardholders at one of client systems 314 by logging onto server system 312 through one of client systems 314. In an alternative embodiment, database 320 is stored remotely from server system 312 and may be non-centralized. Database 320 may store transaction data generated as part of sales activities conducted over the bankcard network including data relating to merchants, account holders or customers, and/or purchases made. Database 320 may also store account data including at least one of a cardholder name, a cardholder address, and an account identifier. Database 320 may also store merchant data including a merchant identifier that identifies each merchant registered to use the payment account card network, and instructions for settling transactions including acquirer account information. Database 320 may also store purchase data associated with items being purchased by a cardholder from a merchant, and authorization request data.

In the example embodiment, one of client systems 314 may be associated with acquirer 108 (shown in FIG. 1) while another one of client systems 314 may be associated with issuer 104 (shown in FIG. 1). POS terminal 315 may be associated with merchant 102 (shown in FIG. 1) and server system 312 may be associated with payment card system interchange network 110. A chargeback request is transmitted by cardholder 106 using client system 314 to an issuer client system 314.

System 300 also includes CB computing device 208 in communication with at least one of client systems 314 and/or server system 312. In the example embodiment, CB computing device 208 is configured to block ineligible chargebacks transactions submitted by issuer 104. In an alternative embodiment, CB computing device 208 may be associated with a payment card network. CB computing device 208 may be interconnected to the Internet through many interfaces including a network, such as a LAN or a WAN, dial-in-connections, cable modems, wireless modems, ISDN lines, and/or fiber optic network lines.

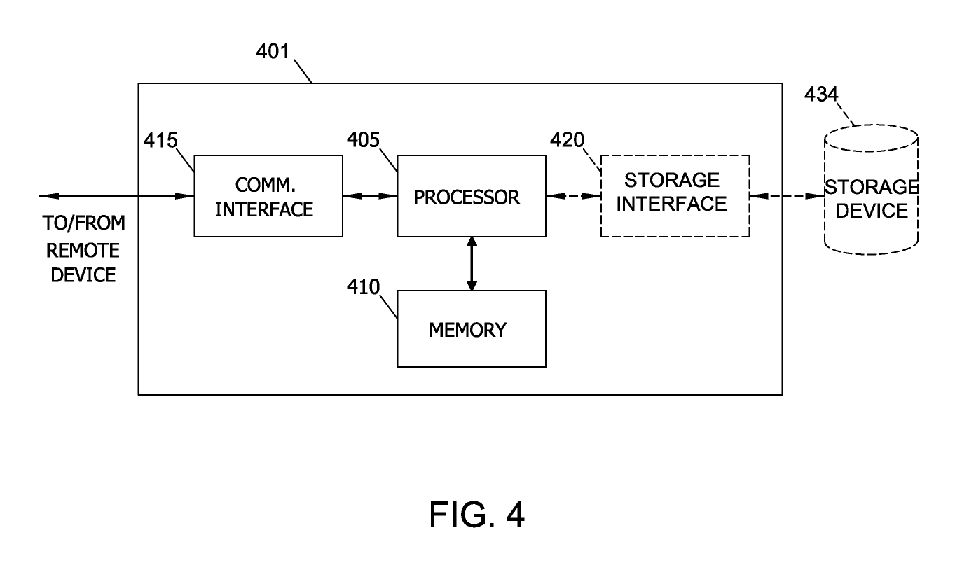

FIG. 4 illustrates an example configuration of a system 401 such as CB computing device 208 and/or payment processor 206 and/or server system 312 (shown in FIGS. 2 and 3). System 401 includes a processor 405 for executing instructions. Instructions may be stored in a memory area 410, for example. Processor 405 may include one or more processing units (e.g., in a multi-core configuration) for executing instructions. The instructions may be executed within various different operating systems on the system 401, such as UNIX®, LINUX® (LINUX is a registered trademark of Linus Torvalds), Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 405 is operatively coupled to a communication interface 415 such that system 401 is capable of communicating with a remote device such as a user system or another system 401. For example, communication interface 415 may receive requests from client system 314 via the Internet, as illustrated in FIG. 4.

Processor 405 may also be operatively coupled to a storage device 434. Storage device 434 is any computer-operated hardware suitable for storing and/or retrieving data. In some embodiments, storage device 434 is integrated in system 401. For example, system 401 may include one or more hard disk drives as storage device 434. In other embodiments, storage device 434 is external to system 401 and may be accessed by a plurality of systems 401. For example, storage device 434 may include multiple storage units such as hard disks or solid state disks in a redundant array of inexpensive disks (RAID) configuration. Storage device 434 may include a storage area network (SAN) and/or a network attached storage (NAS) system.

In some embodiments, processor 405 is operatively coupled to storage device 434 via a storage interface 420. Storage interface 420 is any component capable of providing processor 405 with access to storage device 434. Storage interface 420 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 434.

Memory area 410 may include, but is not limited to, random-access memory (RAM) such as dynamic RAM (DRAM) or static RAM (SRAM), read-only memory (ROM), erasable programmable read-only memory (EPROM), electrically erasable programmable read-only memory (EEPROM), non-volatile RAM (NVRAM), and magneto-resistive random-access memory (MRAM). The above memory types are for example only, and are thus not limiting as to the types of memory usable for storage of a computer program.

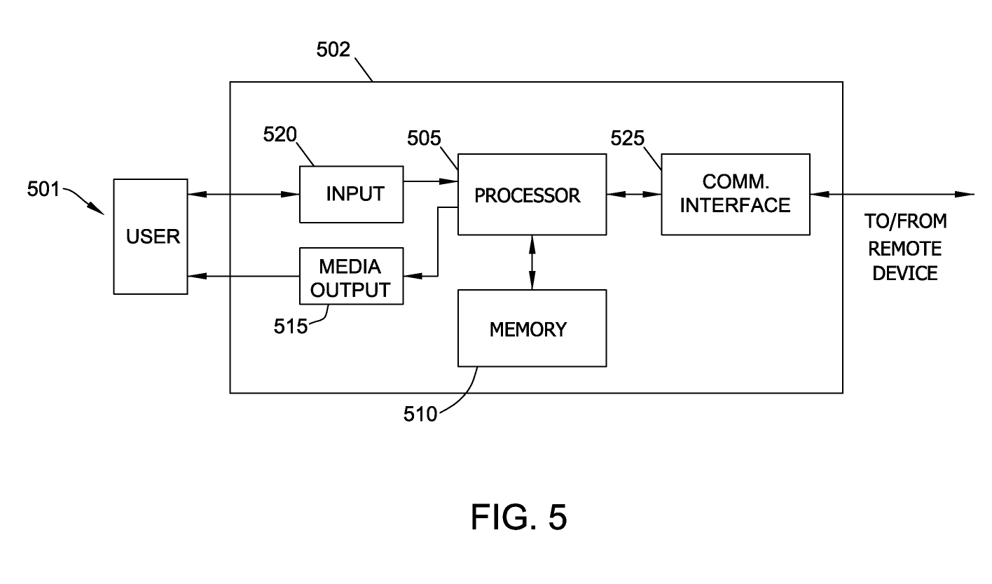

FIG. 5 illustrates an example configuration of a user system 502 operated by a user 501, such as cardholder 106 (shown in FIG. 1). User system 502 includes a processor 505 for executing instructions. In some embodiments, executable instructions are stored in a memory area 510. In some embodiments, executable instructions are stored in a memory area 510. Processor 505 may include one or more processing units (e.g., in a multi-core configuration). Memory area 510 is any device enabling information such as executable instructions and/or other data to be stored and retrieved. Memory area 510 may include one or more computer readable media.

User system 502 also includes at least one media output component 515 for presenting information to user 501. Media output component 515 is any component capable of conveying information to user 501. In some embodiments, media output component 515 includes an output adapter (not shown) such as a video adapter and/or an audio adapter. The output adapter may be operatively coupled to processor 505 and operatively coupleable to an output device such as a display device (e.g., a liquid crystal display (LCD), an organic light emitting diode (OLED) display, a cathode ray tube (CRT), an “electronic ink” display, or an audio output device (e.g., a speaker or headphones).

In some embodiments, user system 502 includes an input device 520 for receiving input from user 501. Input device 520 may include, for example, a keyboard, a keypad, a pointing device, a mouse, a stylus, a touch sensitive panel (e.g., a touch pad or a touch screen), a gyroscope, an accelerometer, a position detector, or an audio input device. A single component, such as a touch screen, may function as both an output device of media output component 515 and input device 520.

User system 502 may also include a communication interface 525, which is communicatively coupleable to a remote device such as server system 312. Communication interface 525 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 510 are, for example, computer readable instructions for providing a user interface to user 501 via media output component 515 and, optionally, receiving and processing input from input device 520. A user interface may include, among other possibilities, a web browser and client application. Web browsers enable cardholders, such as user 501, to display and interact with media and other information typically embedded on a web page or a website from server system 312. A client application enables user 501 to interact with a server application from server system 312.

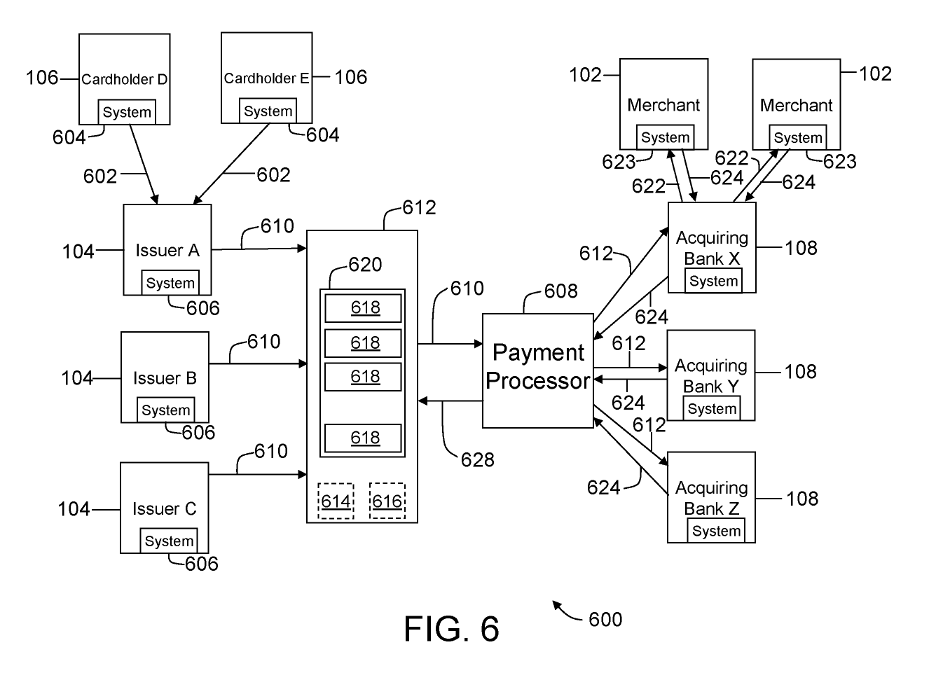

FIG. 6 is a schematic data flow diagram of an example payment card system 600 that includes a CB computing device 612 as also shown in FIGS. 5 and 6 for blocking ineligible chargeback transactions between at least one issuer and at least one acquirer. Payment card system 600 is similar to system 200 shown in FIG. 2.

In the example embodiment, the data flow within system 600 includes transmitting a chargeback request 602 by a cardholder, for example, cardholder 106 (shown in FIG. 1). More specifically, cardholder 106 transmits chargeback request 602 to an issuer, for example, issuer 104 (shown in FIG. 1). Chargeback request 602 is transmitted by cardholder 106 using a cardholder computer system 604, which is similar to client system 314 (shown in FIGS. 3 and 4), to an issuer computer system 606, which is similar to client system 314.

In the example embodiment, chargeback request 602 relates to a request for a chargeback of at least a portion of an original transaction. Chargeback request 602 relates to the original transaction with a merchant, for example, merchant 102 (shown in FIG. 1), that is charged to an account assigned to cardholder 106, where cardholder 106 requests that a chargeback be applied. The original transaction would have been initiated using the payment card issued to cardholder 106 by issuer 104 and would have been processed by a payment processor 608, which is similar to payment server system 312 and/or payment processor 206.

Issuer 104 receives chargeback request 602 from cardholder 106 at issuer computing system 606. In the example embodiment, issuer 104 transmits chargeback request 602 as a chargeback transaction 610 to CB computing device 612, which is similar to CB computing device 208 (shown in FIGS. 2 and 3). Chargeback transaction 610 represents chargeback request 602 submitted by cardholder 106. Chargeback transaction 610 is transmitted from issuer computer system 606 to CB computing device 612. In the example embodiment, chargeback transaction 610 includes transaction data relating to the original transaction.

In the example embodiment, CB computing device 612 blocks ineligible chargeback transactions and transmits eligible chargeback transaction files to payment processor 608 for chargeback settlement. In the example embodiment, CB computing device 612 includes a processor 614 and a memory device 616. In an alternate embodiment, CB computing device 612 may be associated with payment processor 608. Storage device 620 is any computer-operated hardware suitable for storing and/or retrieving data. For example, storage device 620 may include multiple storage units such as hard disks or solid state disks in a redundant array of inexpensive disks (RAID) configuration. Storage device 620 includes data 618 relating to fraud-related chargebacks, including, but not limited to, account identifiers, notification dates, and counter values.

When payment processor 608 receives a chargeback transaction 610 from CB computing device 612, payment processor 608 generates a chargeback transaction file for chargeback transaction 610. In the example embodiment, chargeback transaction file includes detailed transaction records. Merchant 102 receives chargeback request 622 at a merchant computer system 623. While, in an example embodiment, merchant 102 does not respond to chargeback request 622, in another example embodiment, merchant 102 may transmits a chargeback response message 624 acknowledging receipt of chargeback request 622, which is subsequently forwarded by acquirer 108 to payment processor 608.

In some embodiments, payment processor 608 transmits data 626 to CB computing device 612, which can be then transmitted to issuers 104. Data 626 may include chargeback responses, message type code segment, settlement position detail records, and unique file identifiers. Position detail records include updated transaction information. A unique file identifier is the same identifier for each chargeback transaction file when transmitting batch file and is associated with a specific chargeback transaction 610.

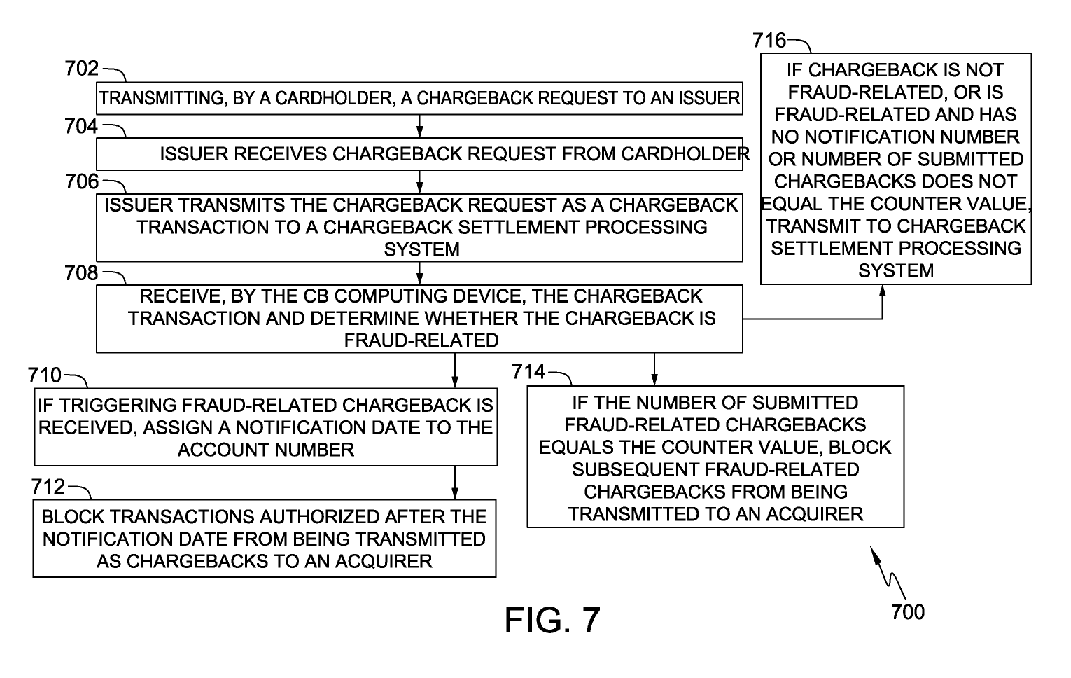

FIG. 7 is a schematic data flow diagram of an example payment card system 700 that includes a CB computing device as shown in FIGS. 2 and 3 for blocking ineligible fraud-related chargebacks based on a notification date or a counter value. Payment card system 700 is similar to system 200 as shown in FIG. 2.

In the example embodiment, the data flow within system 700 includes transmitting 702 a chargeback request by a cardholder to an issuer. The chargeback request is typically transmitted by the cardholder using a cardholder computer system to an issuer computer system.

In the example embodiment, the chargeback request relates to a request for a chargeback of a transaction with a merchant that is charged to an account assigned to the cardholder. The original transaction is initiated using a payment card issued to the cardholder by the issuer and processed by a payment card network. In the example embodiment, the chargeback transaction includes transaction data relating to the original transaction, including an account identifier and a transaction authorization date.

The issuer receives 704 the chargeback request from the cardholder at the issuer computer system. The issuer refunds a transaction amount to the account assigned to the cardholder and determines whether to transmit the transaction for a chargeback with the acquirer.

In the example embodiment, the issuer transmits 706 the chargeback request as a chargeback transaction to the CB computing device. In other embodiments, the chargeback transaction is transmitted to a chargeback settlement processing system, for example, the payment processor shown in FIG. 2, or a network (e.g., a payment processing network, an interchange network, or a clearinghouse network). The chargeback settlement processing system facilitates the clearing, settlement, and chargeback processing of transactions between an acquirer and an issuer (or an issuer processor on behalf of the issuer). The chargeback settlement processing system processes batch file and transmits chargeback transaction files to acquirers through acquirer computer systems for settlement.

In the example embodiment, the CB computing device, in communication with the chargeback settlement processing system and/or the network, receives 708 the chargeback transaction and identifies the account identifier and a reason for the chargeback from the transaction data. If the chargeback is fraud-related, the CB computing device is configured to store the chargeback data into tables in a memory, retrievable by at least the account identifier. Once the CB computing device has received a predefined number of fraud-related chargebacks on the same account identifier, a triggering fraud-related chargeback will trigger 710 the CB computing device to assign a notification date to the account identifier. For example, in some embodiments, the second fraud-related chargeback submitted on the same account identifier is the triggering fraud-related chargeback.

For each fraud-related chargeback, the CB computing device is configured to retrieve the account identifier from the memory to determine whether a notification date is associated with the account identifier. If a notification date is associated with the account identifier, the CB computing device is configured to compare the transaction authorization date with the fraud notification date. If the transaction authorization date is after the notification date, the CB computing device is configured to block 712 the fraud-related chargeback from being submitted to the chargeback settlement processing system and/or an acquirer.

The CB computing device is further configured to verify whether a total number of submitted fraud-related chargebacks on the account identifier equals a predefined counter value. Once the number of submitted fraud-related chargebacks equals 714 the predefined counter value, the CB computing device is configured to block any subsequent fraud-related chargebacks from being submitted to the chargeback settlement processing system and/or the acquirer. As a result, all submitted fraud-related chargebacks exceeding the predefined counter value are blocked from further processing.

If the reason for the chargeback is not fraud-related or the chargeback is fraud-related but the account identifier is not associated with a fraud notification date or the number of submitted fraud-related chargebacks does not exceed the predefined counter value, the CB computing device transmits 816 the chargeback transaction to the chargeback settlement processing system and/or the acquirer.

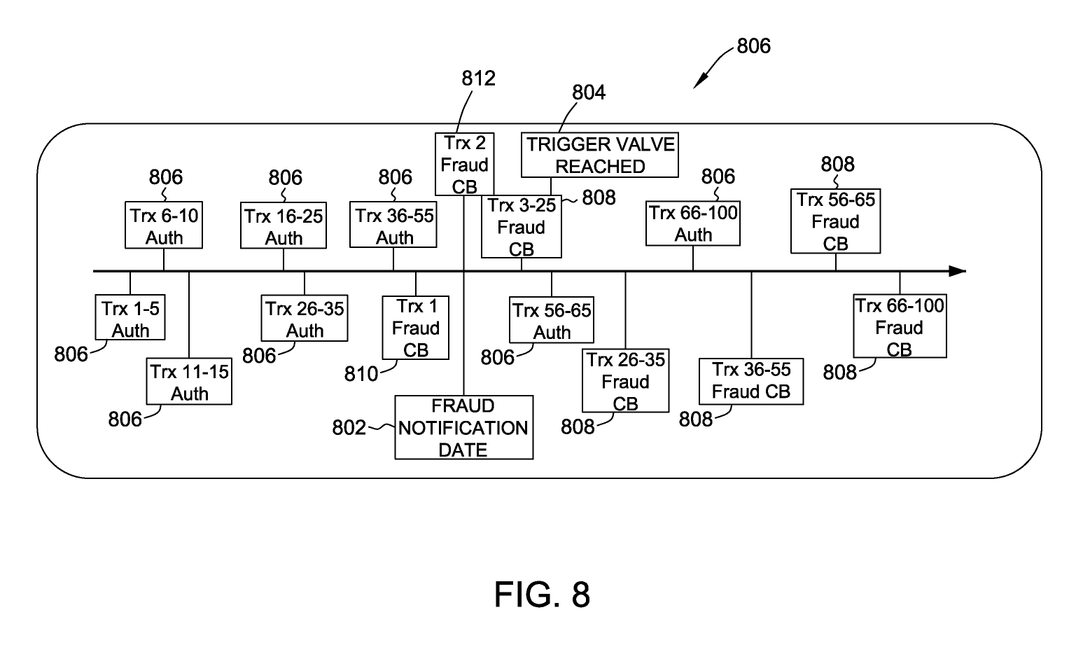

FIG. 8 is a time-line diagram of example transactions 800 being processed by a payment processor and a CB computing device in accordance with one embodiment of the present disclosure. In the example diagram, one hundred payment transactions 806 are authorized by an issuer and subsequently submitted 808 by the issuer to a network (e.g., a payment processing network, an interchange network, or a clearinghouse network) for fraud-related chargebacks. In the example embodiment, the counter value 804 is predefined to twenty-five chargebacks, and a notification date is assigned by the CB computing device to an account identifier on a second fraud-related chargeback submitted by an issuer (not shown).

The issuer submits a first fraud-related chargeback 810 followed by a second fraud-related chargeback 812. On the second fraud-related chargeback 812, the CB computing device assigns a notification date 802 to the account identifier. Prior to the notification date 802, the issuer authorizes fifty-five fraudulent payment transactions (i.e., Trx 1-55 Auth). After notification date 802, the issuer authorizes fifty-five additional fraudulent payment transactions (i.e., Trx 56-100 Auth).

Under solely notification date 802, the CB computing device is configured to block chargebacks related to transactions 56-100 (i.e., Trx 56-100 Fraud CB) as ineligible for being authorized after notification date 802. Conversely, the CB computing device will not block chargebacks related to transactions 1-55 that were authorized prior to notification date 802. As a result, transactions 1-55 will be transmitted via the network to the acquirer for chargeback processing, while transactions 56-100 will be blocked from further transmission.

In addition, under solely counter value 804, transactions 26-100 (i.e., Trx 26-100 Fraud CB) will be blocked by the CB computing device as ineligible for exceeding the counter value. The CB computing device will not block transactions 1-25 for fraud-related chargebacks, which will be transmitted to the acquirer for chargeback processing.

In the example embodiment, the CB computing device will apply both notification date 802 and counter value 804 to transactions 800, resulting in transactions 26-100 being blocked by the CB computing device for exceeding the counter value. The CB computing device will also apply notification date 802 to block transactions 56-100 as ineligible for being authorized after notification date 802; however, these transactions would already be blocked as ineligible for exceeding the counter value.

Example embodiments of methods and systems for blocking ineligible fraud-related chargebacks are described above in detail. The methods and systems are not limited to the specific embodiments described herein, but rather, components of systems and/or steps of the methods may be utilized independently and separately from other components and/or steps described herein. For example, the methods may also be used in combination with other account systems and methods, and are not limited to practice with only the transaction card account systems and methods as described herein. Rather, the example embodiment can be implemented and utilized in connection with many other data storage and analysis applications.

As will be appreciated based on the foregoing specification, the above-described embodiments of the disclosure may be implemented using computer programming or engineering techniques including computer software, firmware, hardware or any combination or subset thereof, wherein the technical effect is a flexible system for various aspects of fraud analysis of payment card transactions. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-implemented method for automatically blocking an ineligible fraud-related chargeback from chargeback processing over a network, the method implemented using a chargeback blocking (CB) computing device including a processor and a memory, said method comprising:
storing triggering rules in the memory, the triggering rules configured to determine whether a fraud-related chargeback is a triggering fraud-related chargeback, wherein the triggering rules include at least one rule defining a notification date for a triggering fraud-related chargeback, and at least one rule defining a counter value for a triggering fraud-related chargeback;
receiving, by the CB computing device from the network, a first chargeback for an account associated with a cardholder, the chargeback including an account identifier;
determining, by the CB computing device, that the first chargeback is a first fraud-related chargeback;
determining, by the CB computing device, that the first fraud-related chargeback is a triggering fraud-related chargeback based at least in part on the stored triggering rules;
receiving, by the CB computing device from the network, a second fraud-related chargeback after determining the first fraud-related chargeback is the triggering fraud-related chargeback;
determining if the second fraud-related chargeback is an ineligible fraud-related chargeback by applying the triggering rules; and
blocking the second fraud-related chargeback from being transmitted over the network if the second fraud-related chargeback is ineligible.

2. The method of claim 1, wherein the notification date is a date the triggering fraud-related chargeback was received by the CB computing device, and wherein the ineligible fraud-related chargeback is associated with a transaction authorized after the notification date.

3. The method of claim 1, wherein the counter value is a predefined number of allowable fraud-related chargebacks that can be submitted in association with the account identifier, wherein the ineligible fraud-related chargeback is a fraud-related chargeback submitted in excess of the counter value.

4. The method of claim 1 further comprising generating, by the CB computing device, a notification to at least one of an issuer and an acquirer associated with the blocked fraud-related chargeback, the notification including a reason code identifying a reason for blocking the fraud-related chargeback.

5. The method of claim 1 further comprising blocking the at least one ineligible fraud-related chargeback from being transmitted over at least one of a payment processing network, an interchange network, and a clearinghouse network for chargeback processing.

6. The method of claim 1, wherein the notification date is associated with the triggering fraud-related chargeback after two fraud-related chargebacks are received in association with the account identifier.

7. The method of claim 1, wherein the counter value is twenty-five fraud-related chargebacks received in association with the account identifier.

8. A chargeback blocking (CB) computing device for automatically blocking an ineligible fraud-related chargeback from chargeback processing over a network, the CB computing device comprising:
a processor; and
a memory coupled to said processor, said processor configured to:
store triggering rules in the memory, the triggering rules configured to determine whether a fraud-related chargeback is a triggering fraud-related chargeback, wherein the triggering rules include at least one rule defining a notification date for a triggering fraud-related chargeback, and at least one rule defining a counter value for a triggering fraud-related chargeback;
receive, from the network, a first chargeback for an account associated with a cardholder, the chargeback including an account identifier;
determine that the first chargeback is a first fraud-related chargeback;
determine that the first fraud-related chargeback is a triggering fraud-related chargeback based at least in part on the stored triggering rules;
receive, from the network, a second fraud-related chargeback after determining the first fraud-related chargeback is the triggering fraud-related chargeback;
determine if the second fraud-related chargeback is an ineligible fraud-related chargeback by applying the triggering rules; and
block the second fraud-related chargeback from being transmitted over the network if the second fraud-related chargeback is ineligible.

9. The CB computing device of claim 8, wherein the notification date is a date the triggering fraud-related chargeback was received by the CB computing device, and wherein the ineligible fraud-related chargeback is associated with a transaction authorized after the notification date.

10. The CB computing device of claim 8, wherein the counter value is a predefined number of allowable fraud-related chargebacks associated with the account identifier, and wherein the ineligible fraud-related chargeback is submitted in excess of the counter value.

11. The CB computing device of claim 8, wherein said processor is further configured to: generate a notification for transmitting to at least one of an issuer and an acquirer associated with the blocked fraud-related chargeback, the notification including a reason code identifying a reason for blocking the fraud-related chargeback.

12. The CB computing device of claim 8, wherein said processor is further configured to block the at least one ineligible fraud-related chargeback from being transmitted over at least one of a payment processing network, an interchange network, and a clearinghouse network for chargeback processing.

13. The CB computing device of claim 8, wherein said processor is further configured to associate the notification date with the triggering fraud-related chargeback after two fraud-related chargebacks are received in association with the account identifier.

14. The CB computing device of claim 8, wherein the counter value is twenty-five fraud-related chargebacks received for the account with the account identifier.

15. Computer-readable storage media having computer-executable instructions embodied thereon, wherein, when executed by at least one processor associated with a chargeback blocking (CB) computing device, the computer-executable instructions cause the processor to:
store triggering rules in the memory, the triggering rules configured to determine whether a fraud-related chargeback is a triggering fraud-related chargeback, wherein the triggering rules include at least one rule defining a notification date for a triggering fraud-related chargeback, and at least one rule defining a counter value for a triggering fraud-related chargeback;
receive, over a network, a first chargeback for an account associated with a cardholder, the chargeback including an account identifier;
determine that the first chargeback is a first fraud-related chargeback;
determine that the first fraud-related chargeback is a triggering fraud-related chargeback based at least in part on the stored triggering rules;
receive, over the network, a second fraud-related chargeback after determining the first fraud-related chargeback is the triggering fraud-related chargeback;
determine if the second fraud-related chargeback is an ineligible fraud-related chargeback by applying the triggering rules; and
block the second fraud-related chargeback from being transmitted over the network if the second fraud-related chargeback is ineligible.

16. The computer-readable storage media in accordance with claim 15, wherein the notification date is a date the triggering fraud-related chargeback was received by the CB computing device, and wherein the ineligible fraud-related chargeback is associated with a transaction authorized after the notification date.

17. The computer-readable storage media in accordance with claim 15, wherein the counter value is a predefined number of allowable fraud-related chargebacks associated with the account identifier, and wherein the ineligible fraud-related chargeback is submitted in excess of the counter value.

18. The computer-readable storage media in accordance with claim 15, wherein the computer-executable instructions cause the processor to generate a notification for transmission to at least one of an issuer and an acquirer associated with the blocked fraud-related chargeback, wherein the notification includes a reason that the fraud-related chargeback was blocked.

19. The computer-readable storage media in accordance with claim 15, wherein the computer-executable instructions cause the processor to block the at least one ineligible fraud-related chargeback from being transmitted over at least one of a payment processing network, an interchange network, and a clearinghouse network for chargeback processing.

20. The computer-readable storage media in accordance with claim 15, wherein the computer-executable instructions cause the processor to associate the notification date with the triggering fraud-related chargeback after two fraud-related chargebacks are received in association with the account identifier.

21. The computer-readable storage media in accordance with claim 15, wherein the counter value is twenty-five fraud-related chargebacks received in association with the account identifier.
